(19) United States
(12) Patent Application Publication
(10) Pub. No.: US 2014/0041265 A1
(43) Pub. Date: Feb. 13, 2014

(54) Leash Sleeve

(71) Applicants: Amy Bassitt Waara, Minneapolis, MN (US); Anthony Thomas Waara, Minneapolis, MN (US)

(72) Inventors: Amy Bassitt Waara, Minneapolis, MN (US); Anthony Thomas Waara, Minneapolis, MN (US)

(21) Appl. No.: 13/495,930

(22) Filed: Aug. 9, 2012

(51) Int. Cl. G09F 21/02

(52) U.S. Cl. CPC G09F 21/02
USPC 40/584

(57) ABSTRACT

The Leash Sleeve is an invention that will provide a way for a dog owner to communicate with other people. The Leash Sleeve is screen printed with whatever saying the owner would like to communicate and then it is sewn into a sleeve that slips onto all standard sized leashes. Some common sayings for the Leash Sleeve are “Adopt Me”, “Therapy Dog”, “Ask to Pet”.

The Leash Sleeve is made of material that is most times 100% cotton but sometimes a polyester/cotton blend. It is sewn and screenprinted.

Your petitioners, Amy Bassitt Waara and Anthony Thomas Waara, both citizens of The United States of America and residents of Minneapolis, Minn. pray that letters patent may be granted for the design for a Leash Sleeve as set forth in the following specification:

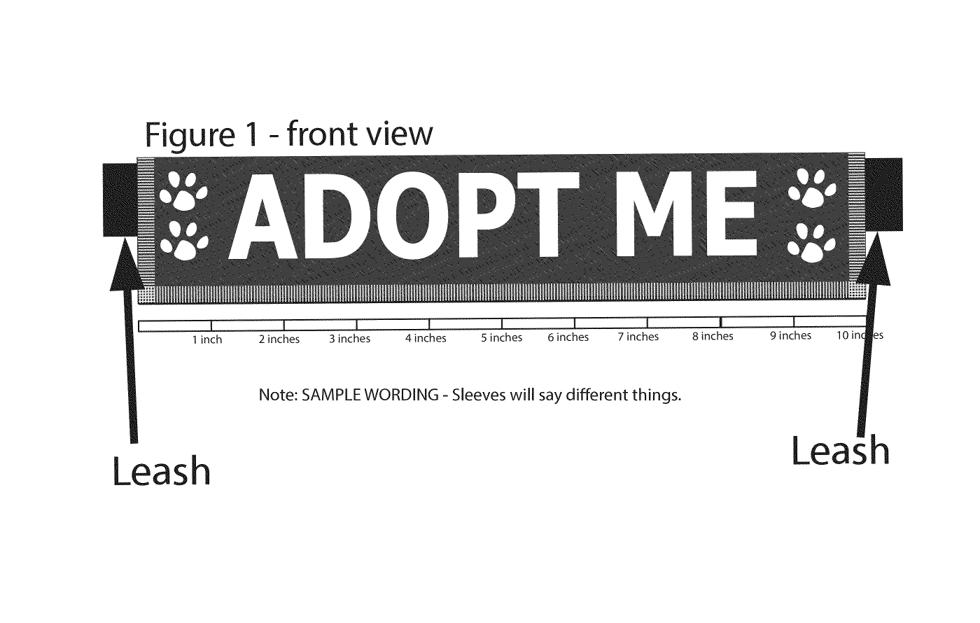

FIG. 1 is a front view of a drawing showing my new design;

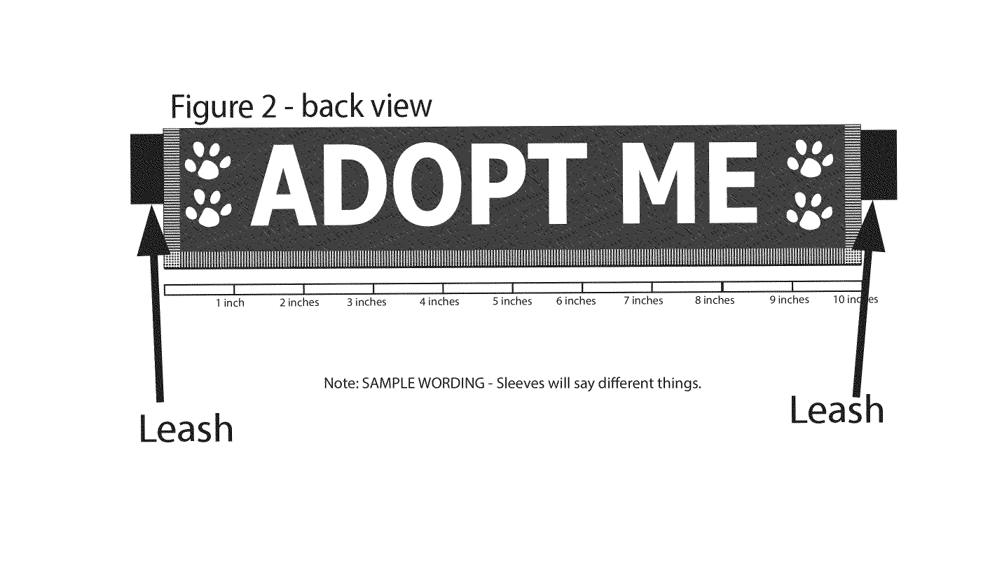

FIG. 2 is a back view thereof;

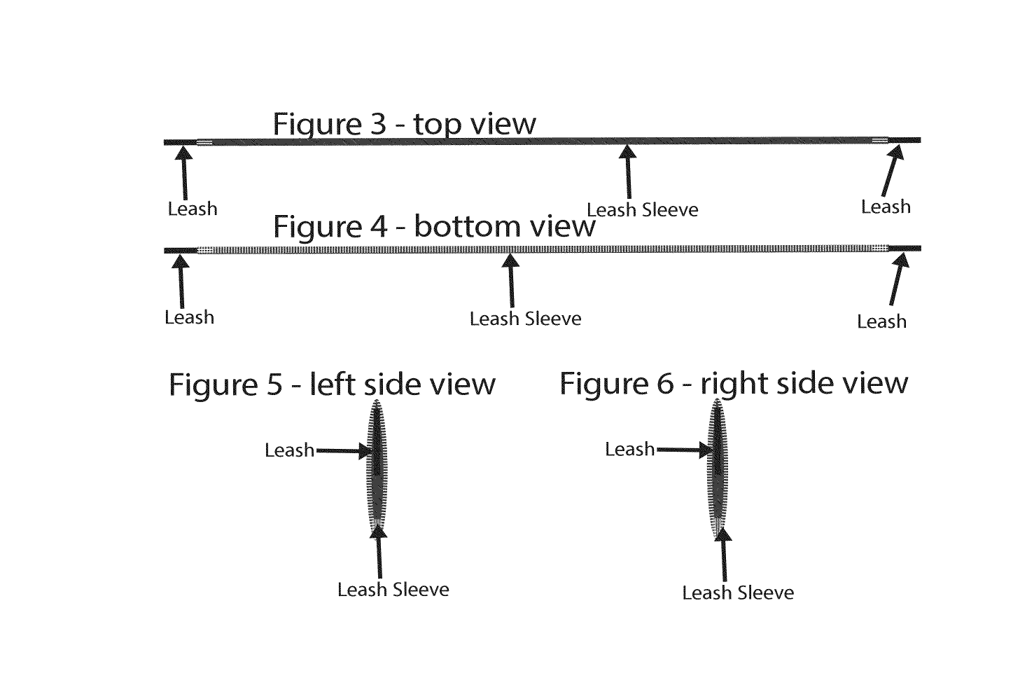

FIG. 3 is a top view thereof;

FIG. 4 is a bottom view thereof;

FIG. 5 is a left side view thereof; and

FIG. 6 is a right side view thereof.

We claim:

1. The ornamental design for a leash sleeve as shown.
